(19) United States
(12) Patent Application Publication
(10) Pub. No.: US 2017/0123933 A1
(43) Pub. Date: May 4, 2017

(54) SYSTEM AND METHOD FOR DISTRIBUTING FILE SYSTEM CHANGES TO REMOTELY LOCATED FILE REPLICAS

(71) Applicant: The Boeing Company, Chicago, IL (US)

(72) Inventors: James Michael Gallagher, Cypress, CA (US); Edmund Takashima, Yorba Linda, CA (US)

(21) Appl. No.: 14/926,293

(22) Filed: Oct. 29, 2015

(51) Int. Cl. G06F 11/14; H04L 29/06; G06F 17/30; H04L 29/08

(52) U.S. Cl. CPC G06F 11/1451; H04L 67/1097; H04L 67/42; G06F 17/30353; G06F 17/30368; G06F 17/30191; G06F 17/30194

(57) ABSTRACT

A system for distributing changes to a replica file system on a client workstation is disclosed including a master file system, a journal database, and an application server. The journal database stores a journal table and a client timestamp, where the journal table includes a plurality of entries listed in chronological order that each represent a modification to the master file system made at a specific point in time. The client timestamp indicates a last point in time when the replica file system was updated. The application server is in communication with the master file system and the journal database. The processor executes instructions for determining the last point in time when the replica file system of the client workstation was updated based on the client timestamp, querying the journal table based on the client timestamp, and locating a specific entry within the journal table based on the client timestamp.

### FIELD

The disclosure relates to a system for distributing updates made to a master file system, and to a system including a journal database for tracking changes made to a master file system.

### BACKGROUND

A master file system may be connected to multiple client workstations using an Internet-based connection, where each client may maintain its own replica of the master file system. Thus, any changes made to the master file system need to be distributed to the various client workstations in order to update the respective replicas. The various client workstations may be located throughout the world, and sometimes in relatively remote or rural areas where Internet connections have a relatively low bandwidth and are sporadic in connectivity.

In light of the above, it may become challenging to distribute the master file system updates to the client workstations. Indeed, the Internet-based connection between the client workstations and the master file system may have a relatively low bandwidth, thereby making the transfer of data between the master file system and the client workstations slow and cumbersome. Furthermore, it should also be appreciated that the client workstations may not be connected to the master file system for relatively long periods of time due to the sporadic Internet connectivity in the area. In some situations, the client workstations may not have network access for several weeks at a time. Additionally, the master file system as well as the replica stored on the client workstation may both be relatively large in size, thereby compounding the challenges that already exist with the transfer and updating of data.

There are directory mirroring tools currently available that may be used to analyze the differences between the file directories of the master file system and the client workstations in order to determine which files to update. However, these directory mirroring tools may have drawbacks. For example, directory mirroring tools may require a significant amount of time to analyze the differences in the file directories between the master file system and the various client workstations. Depending on the size of the file system being mirrored, it may take several minutes or even hours to analyze the differences between the master file system and the various client workstations for every instance when synchronization is executed. It should be appreciated that the client workstations may only have a few hours at a time to synchronize their copies of files with the master file system especially if an Internet connection is unreliable, so any additional time spent to analyze the differences creates a significant impact on the system update.

### SUMMARY

In one aspect, a system for distributing changes to a replica file system on a client workstation is disclosed, and includes a master file system, a journal database, and an application server including a processor. The journal database stores a journal table and a client timestamp, where the journal table includes a plurality of entries listed in chronological order that each represent a modification to the master file system made at a specific point in time. The client timestamp indicates a last point in time when the replica file system was updated. The application server is in communication with the master file system and the journal database. The processor executes instructions for determining the last point in time when the replica file system of the client workstation was updated based on the client timestamp, querying the journal table based on the client timestamp, and locating a specific entry within the journal table based on the client timestamp. The specific entry within the journal table reflects at least one modification to the master file system made subsequent to the last point in time when the replica file system of the client workstation was updated.

In another aspect, a method of updating a replica file system of a client workstation is disclosed. The method comprises initiating a connection between an application server and the client workstation over a network. The application server is in communication with a master file system and a journal database. The method also includes querying the application server, by the client workstation, for any updates which are applicable to the client workstation. The method further includes determining, by a processor of the application server, a last point in time when the replica file system of the client workstation was updated. The method also includes querying a journal table, by the processor of the application server, based on the last point in time when the replica file system was updated. The journal table is stored in a journal database and includes a plurality of entries listed in chronological order that each represent a modification to the master file system made at a specific point in time. Finally, the method includes locating, by the processor of the application server, a specific entry within the journal table based on the last point in time when the replica file system of the client workstation was updated.

Other objects and advantages of the disclosed method and system will be apparent from the following description, the accompanying drawings and the appended claims.

### BRIEF DESCRIPTION OF THE DRAWINGS

FIG. 1 is a block diagram of the disclosed system including an application server connected to a client workstation over a network, a journal database and a master file system;

FIG. 2 is a block diagram illustrating an exemplary computing device that may be used for the application server and the client workstation shown in FIG. 1;

FIG. 3 is a block diagram illustrating the application server shown in FIG. 1 connected to a document management system;

FIG. 4A is an illustration of an exemplary journal table stored within the journal database shown in FIG. 1, where the journal table includes a plurality of entries;

FIG. 4B is an illustration of an exemplary entry stored within the journal table shown in FIG. 4A;

FIG. 5A is an illustration of an exemplary client table stored within the journal database shown in FIG. 1, where the client table includes a unique entry for each client workstation connected to the application server;

FIG. 5B is an illustration of an exemplary client stamp of the client table shown in FIG. 5A;

FIG. 6 is an illustration of an exemplary dialog box that may be shown upon a display of the client workstation during a file synchronization between the application server and the client workstation; and

FIG. 7 is a process flow diagram illustrating an exemplary method of synchronizing the client workstation with the application server with one another to update data stored in a replica file system.

### DETAILED DESCRIPTION

FIG. 1 is an illustration of the disclosed system 10. The system 10 includes a master or application server 20 connected to a client workstation 22 over a network 24. The network 24 may be any type of network for connecting two computing devices together to exchange data such as, for example, the Internet. Although FIG. 1 illustrates only a single client workstation 22, it is to be understood that this illustration is merely exemplary in nature and a single client workstation 22 is illustrated for purposes of simplicity and clarity. Indeed, multiple client workstations 22 may be connected to the application server 20 over the network 24.

In one non-limiting embodiment, the network 24 may connect the application server 20 to the client workstation 22 over relatively long distances. For example, the application server 20 and the client workstation 22 may be located in different countries, or even on different continents of the world. Furthermore, it should also be appreciated that at times, the network 24 between the application server 20 and the client workstation 22 may have intermittent connectivity. For example, sometimes the client workstation 22 may be unable to connect to the network 24 for a period of several days, or even weeks. The client workstation 22 may also only have continuous connectively to the network 24 for a relatively short period of time, such as a few hours. However, it is to be appreciated that the present disclosure is not limited to these specific examples, and that in another embodiment the application server 20 and the client workstation 22 may be connected to one another using a relatively reliable Internet connection as well, and the client workstation 22 may be connected to the network 24 on a daily basis.

The application server 20 may be in communication with a journal database 30 and a master file system 32. The client workstation may be in communication with a replica file system 40. The replica file system 40 may be a copy of the master file system 32. Indeed, as explained in greater detail below, the application server 20 may send updates of the master file system 32 over the network 24, and to the replica file system 40.

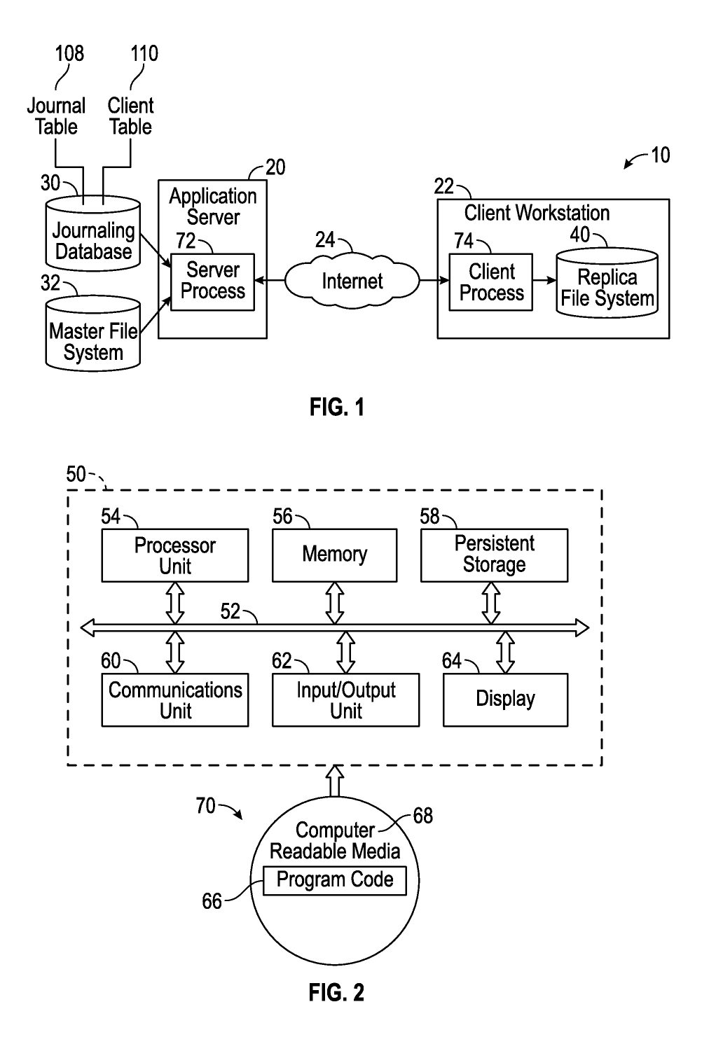

Referring now to FIG. 2, the application server 20 and the client workstation 22 may be implemented on one or more computer devices or systems, such as an exemplary computing device 50. The computing device 50 may include a communications fabric 52 that provides communications between a processor unit 54, a memory 56, persistent storage 58, a communications unit 60, an input/output (I/O) unit 62, and a presentation interface, such as a display 64. In addition to, or in the alternative, the presentation interface may include an audio device (not shown) and/or any device capable of conveying information to a user.

The processor unit 54 executes instructions for software that may be loaded into a storage device, such as the memory 56. The processor unit 54 may be a set of one or more processors or may include multiple processor cores, depending on the particular implementation. Further, the processor unit 54 may be implemented using one or more heterogeneous processor systems in which a main processor is present with secondary processors on a single chip. In another embodiment, the processor unit 54 may be a homogeneous processor system containing multiple processors of the same type.

The memory 56 and the persistent storage 58 are examples of storage devices. As used herein, a storage device is any tangible piece of hardware that is capable of storing information either on a temporary basis and/or a permanent basis. The memory 56 may be, for example, a non-volatile storage device. The persistent storage 58 may take various forms depending on the particular implementation, and the persistent storage 58 may contain one or more components or devices. For example, the persistent storage 58 may be a hard drive, a flash memory, a rewritable optical disk, a rewritable magnetic tape, and/or some combination of the above. The media used by the persistent storage 58 also may be removable. For example, without limitation, a removable hard drive may be used for the persistent storage 58.

A storage device, such as the memory 56 and/or the persistent storage 58, may store data for use with the processes described herein. For example, a storage device may store (e.g., have embodied thereon) computer-executable instructions, executable software components, configurations, layouts, schedules, or any other information suitable for use with the methods described herein. When executed by the processor unit 54, such computer-executable instructions and components cause the processor 54 to perform one or more of the operations described herein.

The communications unit 60, in these examples, provides for communications with other computing devices or systems. In the exemplary embodiment, the communications unit 60 is a network interface component. The communications unit 60 may provide communications through the use of either or both physical and wireless communication links.

The input/output unit 62 enables input and output of data with other devices that may be connected to the computing device 50. For example, without limitation, the input/output unit 62 may provide a connection for user input through a user input device, such as a keyboard and/or a mouse. Further, the input/output unit 62 may send output to a printer. The display 64 provides a mechanism to display information, such as any information described herein, to a user. For example, a presentation interface such as the display 64 may display a graphical user interface, such as those described herein.

Instructions for the operating system and applications or programs are located on the persistent storage 58. These instructions may be loaded into the memory 56 for execution by the processor unit 54. The processes of the different embodiments may be performed by the processor unit 54 using computer implemented instructions and/or computer-executable instructions, which may be located in a memory, such as the memory 56. These instructions are referred to herein as program code (e.g., object code and/or source code) that may be read and executed by a processor in the processor unit 54. The program code in the different embodiments may be embodied on different physical or tangible computer-readable media, such as the memory 56 or the persistent storage 58.

The program code 66 is located in a functional form on non-transitory computer-readable media 68 that is selectively removable and may be loaded onto or transferred to the computing device 50 for execution by the processor unit 54. The program code 66 and computer-readable media 68 form computer program product 70 in these examples. In one example, the computer-readable media 68 may be in a tangible form, such as, for example, an optical or magnetic disc that is inserted or placed into a drive or other device that is part of the persistent storage 58 for transfer onto a storage device, such as a hard drive that is part of the persistent storage 58. In a tangible form, the computer-readable media 68 also may take the form of a persistent storage, such as a hard drive, a thumb drive, or a flash memory that is connected to the computing device 50. The tangible form of the computer-readable media 68 is also referred to as computer recordable storage media. In some instances, the computer-readable media 68 may not be removable.

Alternatively, the program code 66 may be transferred to the computing device 50 from the computer-readable media 68 through a communications link to the communications unit 60 and/or through a connection to the input/output unit 62. The communications link and/or the connection may be physical or wireless in the illustrative examples. The computer-readable media also may take the form of non-tangible media, such as communications links or wireless transmissions containing the program code.

In some illustrative embodiments, the program code 66 may be downloaded over a network to the persistent storage 58 from another computing device or computer system for use within the computing device 50. For instance, program code stored in a computer-readable storage medium in a server computing device may be downloaded over a network from the server to the computing device 50. The computing device providing the program code 66 may be a server computer, a workstation, a client computer, or some other device capable of storing and transmitting the program code 66.

The program code 66 may be organized into computer-executable components that are functionally related. For example, the program code 66 may include one or more part agents, ordering manager agents, supplier agents, and/or any component suitable for practicing the methods described herein. Each component may include computer-executable instructions that, when executed by the processor unit 54, cause the processor unit 54 to perform one or more of the operations described herein.

The different components illustrated herein for the computing device 50 are not meant to provide architectural limitations to the manner in which different embodiments may be implemented. The different illustrative embodiments may be implemented in a computer system including components in addition to or in place of those illustrated for computing device 50. For example, other components shown in FIG. 2 may be varied from the illustrative examples shown. In one example, a storage device in the computing device 50 is any hardware apparatus that may store data. The memory 56, the persistent storage 58 and the computer-readable media 68 are examples of storage devices in a tangible form.

In another example, a bus system may be used to implement the communications fabric 52 and may include one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, without limitation, the memory 56 or a cache such as that found in an interface and memory controller hub that may be present in the communications fabric 52.

Turning back to FIG. 1, a server process 72 may be saved to the memory 56 (FIG. 2) of the application server 20. The server process 72 may be a web server or other software for delivering data over the network 24. A client process 74 may also be saved to the respective memory 56 of the client workstation 22. The client process 74 may be a web browser or other software for retrieving and presenting data from the network 24. The master file system 32 may include plurality of directories, where each directory may contain at least one file. The directories may be organized into a hierarchical structure, which is commonly known and readily appreciated by those of ordinary skill in the art. In one embodiment, the master file system 32 may be relatively large in size. For example, in one embodiment the master file system 32 may more than thirty gigabytes in size, however it is to be appreciated that the master file system 32 may be any size. In one non-limiting embodiment, the master file system 32 may be a repository of two-dimensional (2D) engineering release drawings and the respective supporting documents such as, for example, parts lists and notes lists. It is to be appreciated that the master file system 32 may be updated in order to reflect any changes to the files. For example, if a specific part undergoes an engineering change, then 2D engineering release drawings and the supporting documents are updated to reflect the changes.

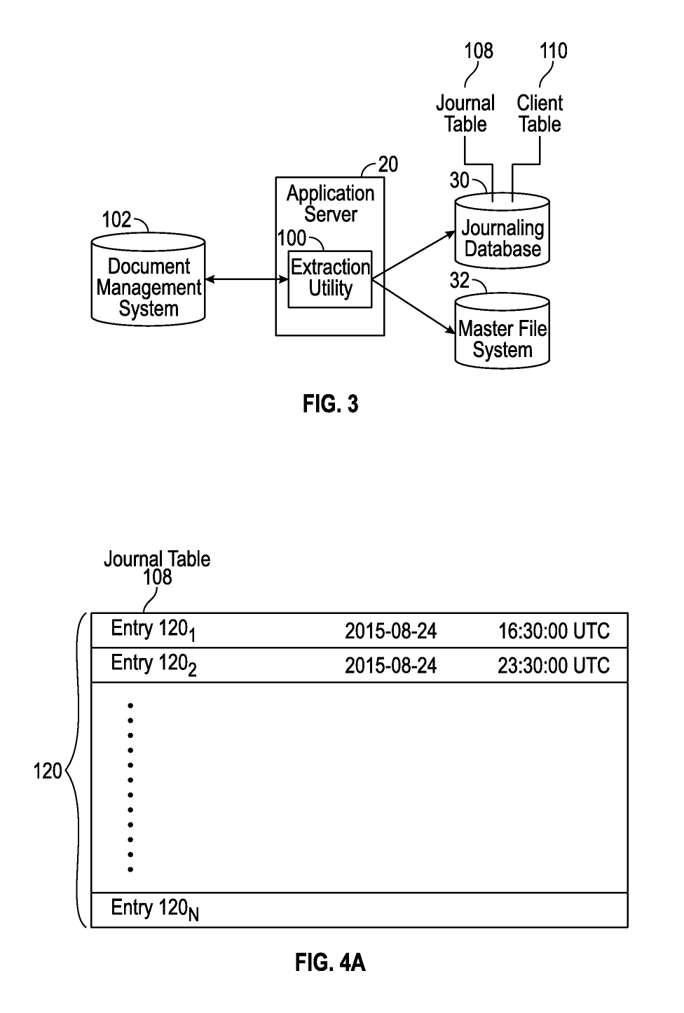

The journal database 30 may be used to track each update or change made to one of the files or directories of the master file system 32. Turning to FIG. 3, changes to the master file system 32 may be tracked using an extraction utility 100. The extraction utility 100 may be a customized program saved to the memory 56 (FIG. 2) of the application server 20, and is executed by the processor 54 (FIG. 2) of the application server 20. As seen in FIG. 3, the extraction utility 100 of the application server 20 may be in communication with the journal database 30, the master file system 32, and a document management system 102. The document management system 102 may track and manage the different versions of files stored in the master file system 32, and is commonly known to those of ordinary skill in the art.

The extraction utility 100 of the application server 20 may monitor the document management system 102 for any updates, such as the addition of new files or directories, or for obsolete files or directories that are deleted. Any new additions to the document management system 102 may be copied to the master file system 32, and the associated update actions may be recorded in the journal database 30. As explained in greater detail below, the associated update actions such as the recording of a new file or directory, as well as the removal or deletion of an obsolete file or directory from the master file system 32 may also be recorded in the journal database 30 by the extraction utility 100.

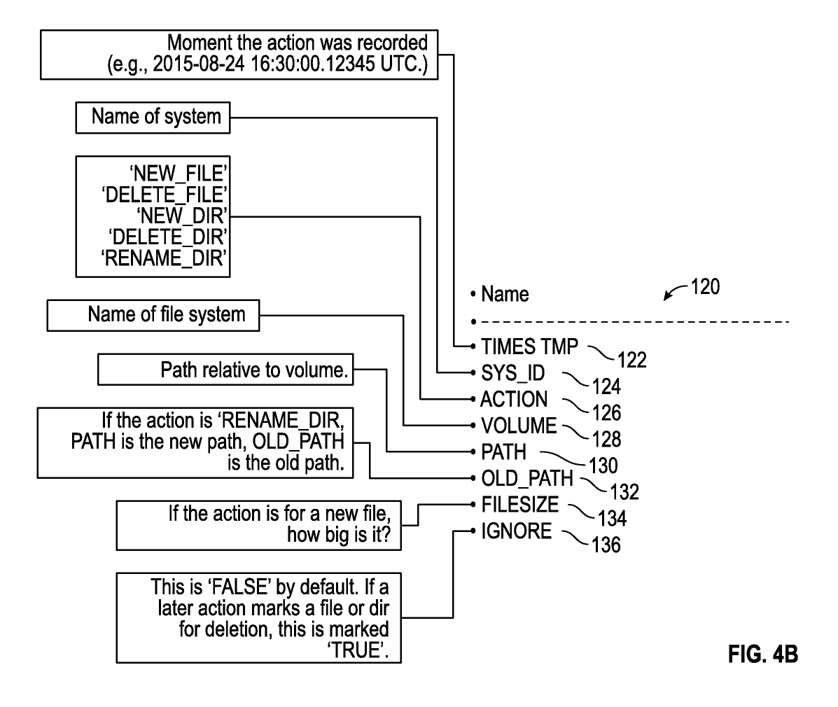

The journal database 30 may store two tables, namely a journal table 108 and a client table 110. FIG. 4A is an exemplary illustration of the journal table 108. As seen in FIG. 4A, a plurality of unique entries 120₁-120_{N} may be created within journal table 108 of the journal database 30. Specifically, a unique entry 120 is recorded within the journal table 108 every time a file or a directory within the master file system 32 is modified. The entries 120 are listed in chronological order, where each entry 120 represents a modification to the master file system made at a specific point in time. Specifically, the first entry 120₁ is recorded at some point in time, and the remaining entries 120₂-120_{N} are recorded at subsequent points in time after the initial entry 120₁. FIG. 4B is an illustration of a single entry 120 made within the journal table 108 of the journal database 30 (FIG. 4A) by the extraction utility 100 of the application server 20 (FIG. 3) if a file or a directory is modified (i.e., a file or directory is either copied to or deleted from the master file system 32).

As seen in FIG. 4B, a unique entry 120 within the journal table 108 (FIG. 4A) may include a timestamp 122, a system identifier 124, an action 126, a volume 128, a path 130, an old path 132, a file size 134, and a deletion field 136. Referring to FIGS. 1, 3, and 4A-4B, the timestamp 122 represents a specific point in time when a file or a directory within the master file system 32 is modified. It is to be appreciated that the timestamp 122 is defined with sufficient resolution such that no two timestamps 122 would have identical values. For example, in one approach the timestamp 122 is generated with a resolution of 1/100,000 of a second. Modification of the master file system 32 includes the addition or deletion of a specific file or directory, or if a directory has been re-named within the master file system 32. For example, in the embodiment as shown in FIG. 4A, the master file system 32 was modified on Aug. 24, 2015, at 4:30 pm. The system identifier 124 indicates a unique name or identifier associated with the document management system 102 (FIG. 3). The action 126 provides an indication of the type of modification to the master file system 21. For example, the action 126 may indicate if a file or a directory has been added to the master file system 32, if the specific file or directory was deleted from the master file system 32, or if a directory has been re-named within the master file system 32. The path 130 indicates the specific location within the file system relative to the volume 128. The path 130 may indicate, for example, the specific folder and/or sub-folder where a file is stored, or where a specific directory is located within the master file system 32. The old path 132 indicates the location within the master file system 32 where a previous copy of a directory or a file was saved, if applicable (i.e., if a directory or a file has been re-named). It is to be appreciated that a file system may contain multiple volumes 128. Specifically, the volume 128 may be a network share (also referred to as a shared resource), where the path 130 and the old path 132 are directories or files on the volume 128. The file size 134 indicates the size of a newly added file or directory, if applicable. Finally, the deletion field 136 is marked FALSE by default. However, if a later action indicates that a specific file or directory is to be deleted from the master file system 32, then the deletion field 136 is marked as TRUE.

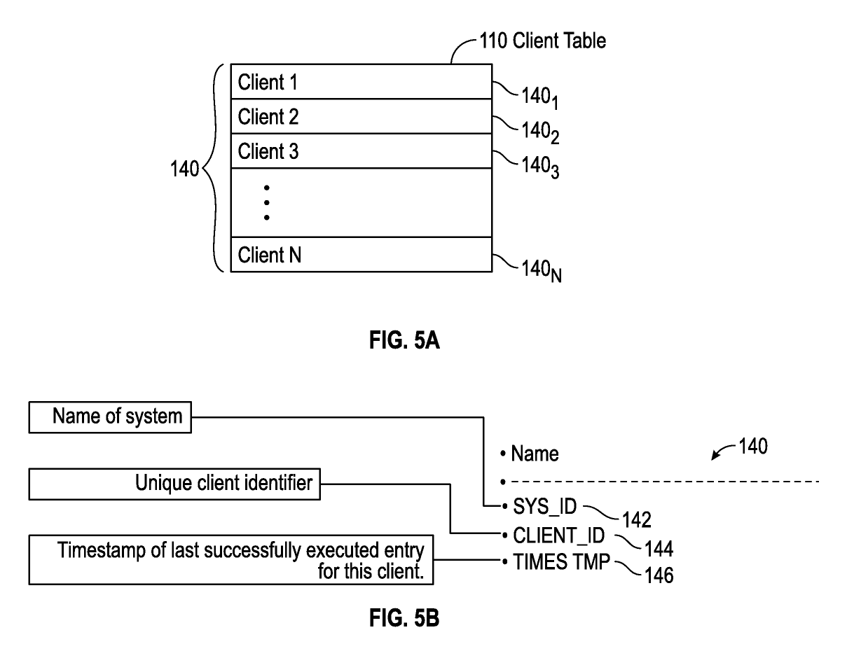

FIG. 5A is an exemplary illustration of the client table 110. As seen in FIG. 5A, the client table 110 includes a plurality of client stamps 140. Referring to FIGS. 1, 3, and 5A, a unique client stamp 140 exists within the client table 110 of the journal database 30 for each client workstation 22 that is in communication with the application server 20 through the network 24. For example, if twenty unique client workstations 22 were connected to the application server 20 through the network 24 (i.e., N=20), then twenty unique client stamps 140 would exist within the client table 110 of the journal database 30.

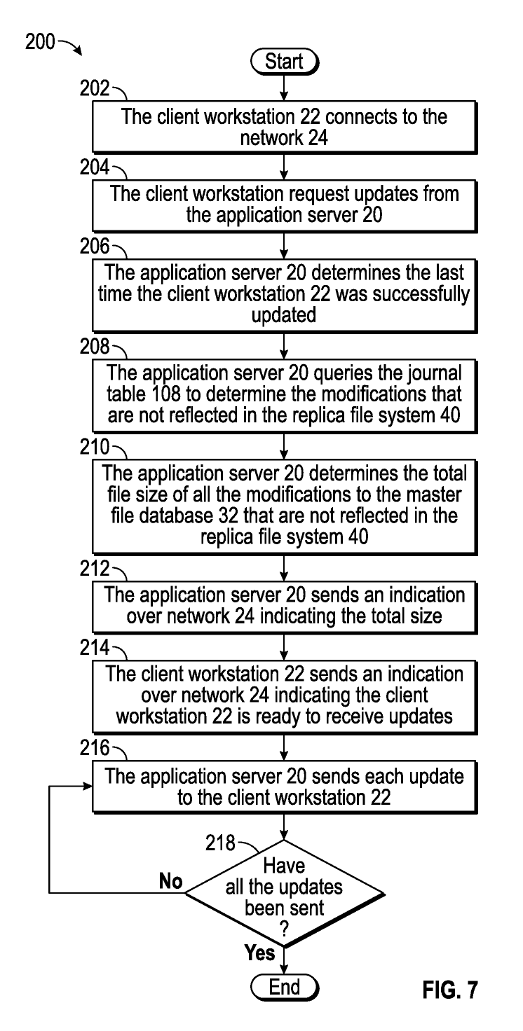

FIG. 5B is an exemplary illustration of a single client stamp 140. The client stamp 140 may include a system identifier 142, a client identifier 144, and a client timestamp 146. The system identifier 142 indicates the unique name or identifier associated with the document management system 102. The client identifier 144 indicates a unique name or identifier associated with the client workstation 22 (FIG. 1) that the client stamp 140 represents. For example, if the client workstation 22 associated with the client stamp 140 is JDoe1, then the unique client identifier 144 would be JDoe1. The timestamp 146 indicates a last point in time when the replica file system 40 of the client workstation 22 (FIG. 1) was successfully updated to reflect any modifications to the master file system 32. As explained in greater detail below and described in the exemplary process flow diagram in FIG. 7, the application server 20 may update the timestamp 146 to indicate a date and time of the last time the replica file system 40 was updated.

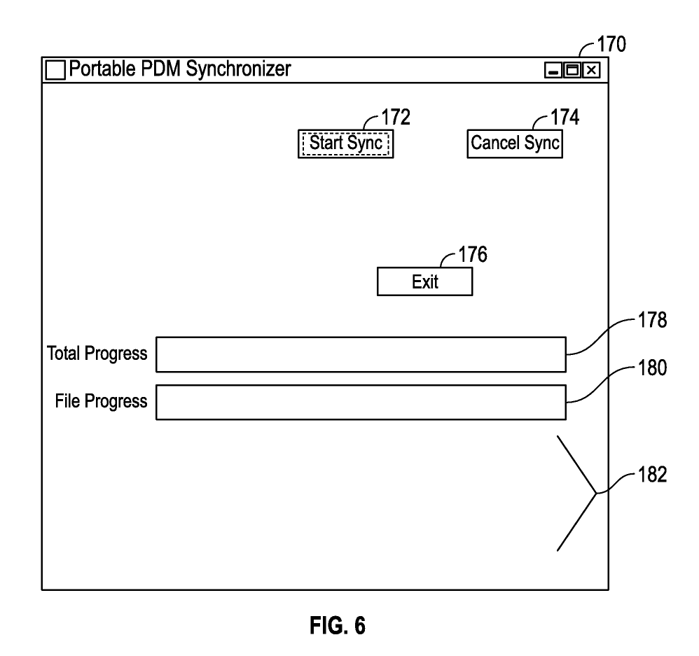

FIG. 6 is an exemplary illustration of a dialog box 170 that may appear upon the display 64 (FIG. 2) of the client workstation 22 if a user initiates a file synchronization with the application server 20 (FIG. 1). As seen in FIG. 6, the dialog box 170 may include a start button 172, a cancel button 174, and exit button 176, a total progress bar 178, a file progress bar 180, and a dialog area 182. The total progress bar 178 tracks the overall progress of the file synchronization with the application server 20 based on a number of bytes of new files that are transferred. The file progress bar 180 tracks the progress of an individual file being transferred from the application server. The dialog box 182 may be used to display information regarding speed and synchronization of a transaction between the application server 20 and the client workstation 22. For example, the dialog box may include the speed of the file synchronization (e.g., the bytes per second being transferred), as well as which specific file or directory is currently being updated within the replica file system 40.

FIG. 7 is a process flow diagram illustrating an exemplary method 200 for synchronizing the client workstation 22 with the application server 20 to update data stored in the replica file system 40. Thus, the data stored in the replica file system 40 should reflect any updates or modifications made to the data stored in the master file system 32. Referring generally to FIGS. 1-6, the method 200 may begin if a user selects the start button 172 of the dialog box 170 (FIG. 6). As explained above, the dialog box 170 may be shown upon a display 64 (FIG. 2) of the client workstation 22. Method 200 may then proceed to block 202. In block 202, the client workstation 22 may connect to the network 24. The network 24 is connected to the application server 20. Method 200 may then proceed to block 204.

In block 204, the client workstation 22 may query the application server 20 for any updates specific to the document management system 102, which are applicable to the specific client workstation 22. For example, if the client workstation 22 includes the client identifier JDoe1, then the client workstation 22 queries the application server 20 for any updates that are applicable to JDoe1. Method 200 may then proceed to block 206.

In block 206, the processor 54 of the application server 20 queries the client table 110 (FIG. 5A) stored within the journal database 30 based on the client identifier 144 (FIG. 5B) associated with the client workstation 22. The query is made in order to determine the last time when the client workstation 22 was successfully updated to reflect any modifications to the master file system 32. Specifically, the application server 20 first locates the specific client stamp 140 within the client table 110 that is associated with the client workstation 22. Then the application server 20 determines the last time the client workstation 22 was successfully updated based on the timestamp 146 associated with the specific client stamp 140 (FIG. 5B). Method 200 may then proceed to block 208.

In block 208, the processor 54 of the application server 20 queries the journal table 108 of the journal database 30 based on the timestamp 146 determined in block 206 above to determine the modifications to the master file system 32 that are not reflected within the replica file system 40 of the client workstation 22. Specifically, the processor 54 of the application server 20 queries the journal table 108 based on the timestamp 146, and locates a specific entry 120 within the journal table 108 that reflects a modification made to the master file system 32 made subsequent to the last point in time when the replica file system 40 of the client workstation 22 was updated.

For example, with specific reference to FIGS. 1, 2, and 4A-4B, the processor 54 of the application server 20 may query the timestamp 122 of each entry 120₁-120_{N} within the journal table 108 in order to determine which entry 120₁-120_{N} includes modifications to the master file system 32 which are not reflected within the replica file system 40 of the client workstation 22. In the embodiment as shown, the first entry 120₁ was recorded at Aug. 24, 2015, at 4:30 pm based on Coordinated Universal Time (UTC) (i.e., 2015-08-24, at 16:30:00 UTC). The second entry 120₂ was recorded at Aug. 24, 2015 at 11:30 pm (i.e., 2015-08-24, at 23:30:00 UTC). For purposes of explaining the present example, the timestamp 146 of the unique client identifier 144 associated with the client workstation 22 is Aug. 24, 2015 at 8:35 pm. Thus, the processor 54 of the application server 20 determines that the replica file system 40 of the client workstation 22 does not include the modifications that are represented in entry 120₂, nor any of the entries 120₃-120_{N} which are subsequent to the entry 120₂. Method 200 may then proceed to block 210.

In block 210, the processor 54 of the application server 20 may then determine a total file size of all of the modifications to the master file system 32 that are not currently reflected in the replica file system 40. Specifically, the application server 20 may determine the file size of all modifications that are not reflected within the replica file system 40 of the client workstation 22 by summing or adding together the file size of each individual entry 120 within the journal table 108 that represents a modification not reflected within the replica file system 40 of the client workstation 22. For example, if the replica file system 40 of the client workstation 22 does not include the modifications that are represented in entries 120₂-120_{N} (FIG. 4A), then the processor 54 of the application server 20 may determine the total file size by summing together the files represented by each of the entries 120₂-120_{N} listed within the journal table 108 (FIG. 4A). Method 200 may then proceed to block 212.

In block 212, the application server 20 may then send an indication over the network 24 indicating the total file size of all the modifications to the master file system 32 that are not currently reflected in the replica file system 40 to the client workstation 22. It should be appreciated that the client workstation 22 may use the total file size in order to update the total progress bar 178 shown in FIG. 6, which tracks the overall progress of the file synchronization with the application server 20. Method 200 may then proceed to block 214.

In block 214, the client workstation 22 may send an indication over the network 24 and to the application server 20 signifying that the client workstation 22 is ready, and may receive updates to its replica file system 40. Method 200 may then proceed to block 216.

In block 216, the application server 20 may send updates to the client workstation 22 over the network 24. The updates include each and every modification to the master file system 32 made subsequent to the last point in time when the replica file system 40 of the client workstation 22 was updated. In the present example, with reference to FIGS. 1, 3, and 4A-4B, the updates that are represented in entries 120₂-120_{N} of the journal table 108 may each be sent individually from the application server 20 to the client workstation 22 over the network 24. It should be appreciated that the total progress bar 178 of the dialog box 170 may be updated accordingly to reflect the overall progress of the file synchronization during the update.

Furthermore, it is to be appreciated that as each individual update is sent to the client workstation 22 over the network 24, the timestamp 146 (FIG. 5B) of the client stamp 140 listed in the client table 110 (FIG. 5A) will be updated accordingly. Specifically, the timestamp 146 of the client stamp 140 will be updated to match the timestamp 122 (shown in FIG. 4B) of a specific entry 120 within the journal table 108 (FIG. 4A). For example, if an update based on the entry 120₂ (shown in FIG. 4A) is sent over the network 24, then the timestamp 146 of the client stamp 140 may be updated to Aug. 24, 2015 at 11:30 pm. Method 200 may then proceed to block 218.

In block 218, once all of the updates have been sent to the client workstation 22, then method 200 may then terminate. It is to be appreciated that method 200 may also terminate in the event a user of the client workstation 22 terminates the file synchronization. Alternatively, the method 200 may also terminate in the event the network 24 becomes unavailable.

Referring generally to the figures, the disclosed system provides an approach for quickly and efficiently determining the differences between the master file system and the replica file system. It should also be appreciated that the disclosed system does not require differential analysis of the master file system and the replica file system. Moreover, each change may be propagated to a client workstation only once. Furthermore, file synchronization may be interrupted at any time, and the next file synchronization may still resume at the point in time where the last change to the replica file system was performed. Thus, the client workstations may progressively synchronize the data stored within its replica file system in short sessions. This may be especially advantageous if the client workstation is located in an area where Internet connectively is relatively slow or sporadic.

While the forms of apparatus and methods herein described constitute preferred aspects of this disclosure, it is to be understood that the disclosure is not limited to these precise forms of apparatus and methods, and the changes may be made therein without departing from the scope of the disclosure.

What is claimed is:

1. A system for distributing changes to a replica file system on a client workstation, the system comprising:
a master file system;
a journal database storing a journal table and a client timestamp, wherein the journal table includes a plurality of entries listed in chronological order that each represent a modification to the master file system made at a specific point in time, and the client timestamp indicates a last point in time when the replica file system was updated; and
an application server including a processor, wherein the application server is in communication with the master file system and the journal database, and wherein the processor executes instructions for:
determining the last point in time when the replica file system of the client workstation was updated based on the client timestamp;
querying the journal table based on the client timestamp; and
locating a specific entry within the journal table based on the client timestamp, wherein the specific entry within the journal table reflects at least one modification to the master file system made subsequent to the last point in time when the replica file system of the client workstation was updated.

2. The system of claim 1, wherein the plurality of entries within the journal table each include a unique timestamp, and wherein the unique timestamp represents the modification to the master file system made at the specific point in time.

3. The system of claim 1, wherein the master file system includes a plurality of directories that each include at least one file.

4. The system of claim 3, wherein the modification to the master file system is one of: an addition of a file, a deletion of a file, adding a directory to the plurality of directories, a deletion of one of the plurality of directories, and a re-naming of one of the plurality of directories.

5. The system of claim 1, wherein the application server is connected to a network, and wherein the processor of the application server executes an instruction for sending an update over the network to the client workstation.

6. The system of claim 5, wherein the update is based on a specific modification to the master file system that is represented by a single entry of the plurality of entries within the journal table.

7. The system of claim 6, wherein the application server updates the client timestamp to match a timestamp associated with the single entry of the plurality of entries within the journal table.

8. The system of claim 1, wherein the master file system is a repository of two-dimensional (2D) engineering release drawings and respective supporting documents.

9. The system of claim 1, wherein the application server is in communication with a plurality of client workstations that each include a respective replica file system over a network.

10. The system of claim 9, wherein the journal database stores a client table that includes a plurality of unique client stamps that each correspond to one of the plurality of client workstations.

11. The system of claim 10, wherein the plurality of unique client stamps each include a respective timestamp that indicates a point in time when the respective replica file system was updated.

12. The system of claim 1, wherein the replica file system is a copy of the master file system.

13. The system of claim 1, wherein the application server is in communication with a document management system, and wherein an extraction utility saved in a memory of the application server monitors the document management system for updates.

14. A method of updating a replica file system of a client workstation, the method comprising:
initiating a connection between an application server and the client workstation over a network, wherein the application server is in communication with a master file system and a journal database;
querying the application server, by the client workstation, for any updates which are applicable to the client workstation;
determining, by a processor of the application server, a last point in time when the replica file system of the client workstation was updated;
querying a journal table, by the processor of the application server, based on the last point in time when the replica file system was updated, wherein the journal table is stored in a journal database and includes a plurality of entries listed in chronological order that each represent a modification to the master file system made at a specific point in time; and
locating, by the processor of the application server, a specific entry within the journal table based on the last point in time when the replica file system of the client workstation was updated.

15. The method of claim 14, comprising sending an update from the application server to the client workstation over the network, wherein the update is based on a specific modification to the master file system that is represented by a single entry of the plurality of entries within the journal table.

16. The method of claim 15, comprising updating a client timestamp that is stored in the journal database by the processor of the application server, wherein the client timestamp indicates the last point in time when the replica file system was updated.

17. The method of claim 14, wherein the specific entry within the journal table reflects a plurality of modifications to the master file system made subsequent to the last point in time when the replica file system of the client workstation was updated.

18. The method of claim 17, comprising determining a total file size of the plurality of modifications to the master file system by the processor of the application server.

19. The method of claim 14, wherein the master file system includes a plurality of directories that each include at least one file, and wherein the modification to the master file system is one of: an addition of a file, a deletion of a file, adding a directory to the plurality of directories, a deletion of one of the plurality of directories, and a re-naming of one of the plurality of directories.

20. The method of claim 14, wherein the replica file system is a copy of the master file system.
